(19) United States
(12) Patent Application Publication
(10) Pub. No.: US 2015/0066614 A1
(43) Pub. Date: Mar. 5, 2015

(54) PROMOTION WITH FRIENDS

(71) Applicant: Facebook, Inc., Menlo Park, CA (US)

(72) Inventors: Thomas German Gilmartin, Burlingame, CA (US); Thomas Brown, Menlo Park, CA (US); Andrew Edward McKeon, Menlo Park, CA (US)

(73) Assignee: Facebook, Inc., Menlo Park, CA (US)

(21) Appl. No.: 14/015,721

(22) Filed: Aug. 30, 2013

(51) Int. Cl. G06Q 50/00; G06Q 30/02

(52) U.S. Cl. CPC G06Q 50/01; G06Q 30/0212
USPC 705/14.14

(57) ABSTRACT

Exemplary methods and apparatuses facilitate a promotion for users of a social networking system by receiving a promotional identifier from a user device of a first user in the social networking system and entering the first user into the promotion. Selection of a second user for participation in the promotion is received from the first user. In response to receiving an indication that the second user has completed an action within the social networking system, the likelihood of the first user winning an award or the quality of the award is increased.

### FIELD

The various embodiments described herein relate to facilitating a promotion, such as a contest or sweepstake, within a social network. In particular, the embodiments relate to the utilization of a social networking platform to increase user engagement with a product, advertiser, or another entity by incentivizing and facilitating collaboration with other users.

### BACKGROUND

A social networking system allows users to designate other users or entities as connections (or otherwise connect to, or form relationships with, other users or entities), contribute and interact with their connections, use applications, join groups, list and confirm attendance at events, invite connections, and perform other tasks that facilitate social interaction. External applications also use the services of a social networking system to allow authenticated users to incorporate some of the above social interactions with use of the external applications. External applications are useful for promoting consumer products by providing a vehicle for increasing product recognition and impact.

### SUMMARY OF THE DESCRIPTION

Exemplary methods and apparatuses facilitate a promotion for users of a social networking system by receiving a promotional identifier from a user device of a first user in the social networking system and entering the first user into the promotion. Selection of a second user for participation in the promotion is received from the first user. In response to receiving an indication that the second user has completed an action within the social networking system, the likelihood of the first user winning an award or the quality of the award is increased. In one embodiment, exemplary methods and apparatuses increase the likelihood of the user winning an award or increase the quality of the award in response to a group or chain of users growing in number or length.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 is a flow chart illustrating an exemplary method of implementing a promotion through a social network;

FIG. 2 is a flow chart illustrating another exemplary method of implementing a promotion through a social network;

FIG. 3 illustrates an exemplary graph of social network data;

FIG. 4 illustrates, in block diagram form, an exemplary social network;

FIG. 5 illustrates, in block diagram form, an exemplary processing system to implement an embodiment of a promotion;

### DETAILED DESCRIPTION

Embodiments described herein facilitate a promotion for users of a social networking system. Utilizing the interactive and connected nature of the social network, users are incentivized to leverage social connections to increase participation and engagement with the promotion.

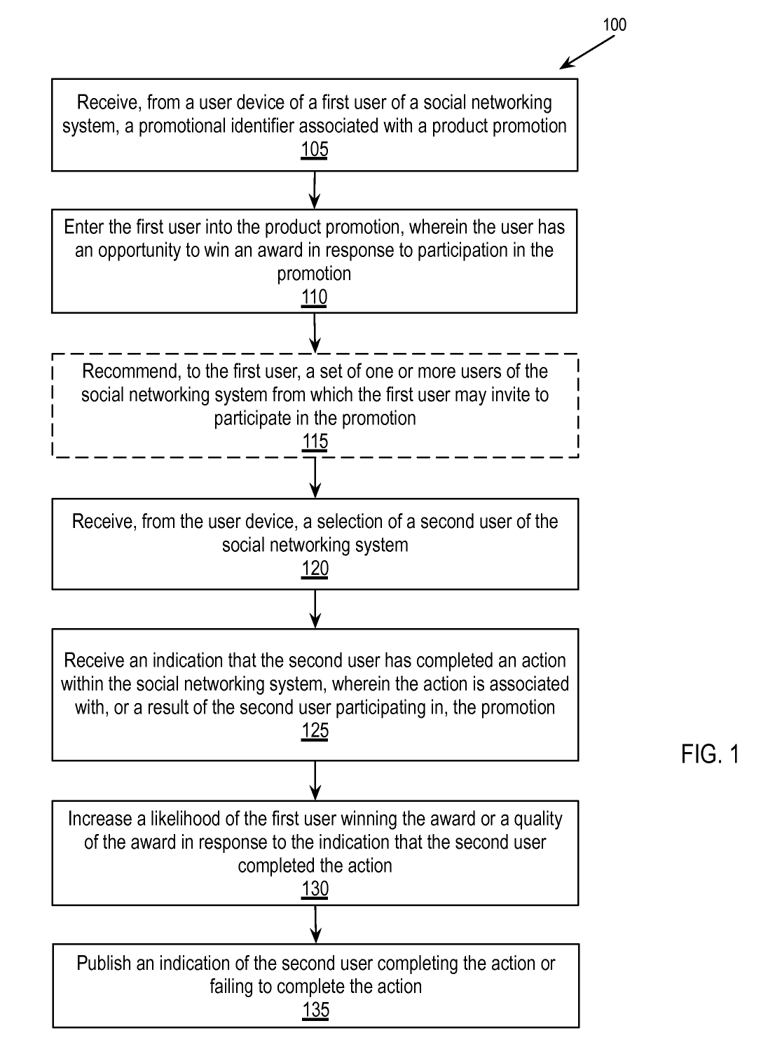

FIG. 1 is a flow chart illustrating an exemplary method 100 of implementing a product promotion through a social network. While method 100 is described as being performed by a social networking system, method 100 may also be performed by an external product promotion application in cooperation with the social networking system. At block 105, a social networking system receives, from a user device of a first user of the social networking system, a promotional identifier associated with a product promotion. The promotional identifier can be a code or proof of purchase. For example, a user obtains a promotional identifier from under the cap (UTC) of a bottled drink or otherwise on the packaging of a product. Alternatively, the user obtains the promotional identifier via an email, webpage, or mail.

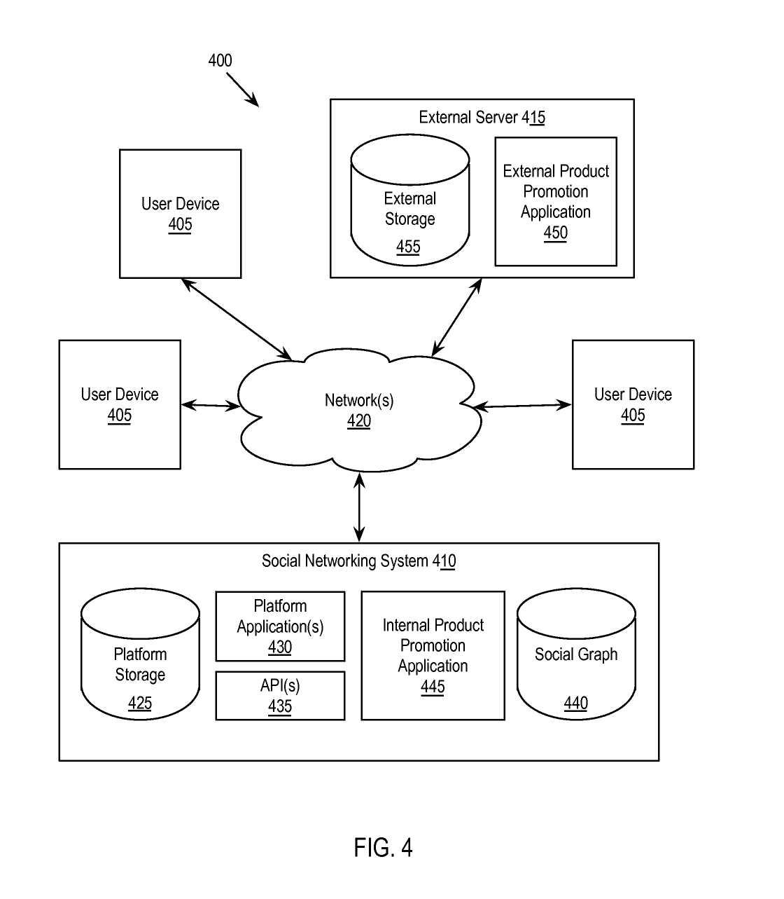

In one embodiment, the user enters the promotional identifier into a product promotion application (e.g., as described with reference to FIG. 4) that is external to the social networking system. The external product promotion application operates in a cooperative manner with the social networking system (e.g., enabling access to user connections, having permission to publish posts, etc.). In an alternative embodiment, the user enters the promotional identifier into a promotional application that is an internal application of or otherwise operates within or as a part of the social networking system.

At block 110, the social networking system enters the first user into the product promotion. As used herein, “product promotion” includes promotions, contests, sweepstakes, etc. related to the promotion of a product, a company, an entity (e.g., a performer), etc. As a result of the user's participation in the promotion, the user has an opportunity to win an award.

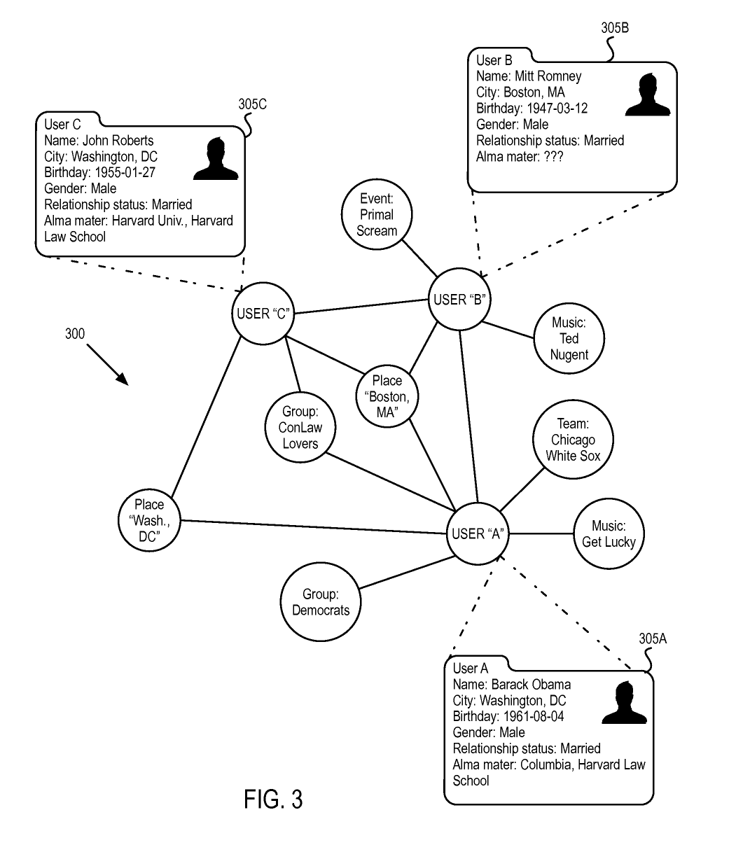

At block 115, the social networking system optionally recommends, to the first user, a set of one or more users of the social networking system from which the first user may invite to participate in the promotion. In one embodiment, the recommendation is based on an association within the social networking system between the first user and each recommended user. In another embodiment, the recommendation is based on an association within the social networking system between each recommended user and the product promotion. An association is a connection or commonality, reflected in social network data (e.g., as described with reference to FIG. 3), between two users of the social networking system or a relationship between a user and the promotion. Exemplary associations between two users include: a direct connection as friends, shared interests or similar demographics, “liking” the same product, downloading the same application, and prior engagement or participation with the same product or promotion. Exemplary associations between a user and a promotion include: liking the product or company that is involved in a promotion, having similar demographics to individuals that typically purchase a certain product, being connected to individuals that are fans of or like a product or company, participating in a product promotion, and prior engagement with a company.

At block 120, the social networking system receives, from the first user device, a selection of a second user of the social networking system for participation in the product promotion. For example, the first user may select the second user following a recommendation from the social networking system, as described above, by clicking on a graphical representation of the second user (e.g., the second user's profile picture, a picture containing the second user's face, the second user's name, etc.). Alternatively, the first user may select the second user from the first user's social network connections, or manually enter the username, email address, or another identifier of the second user.

In one embodiment, the social networking system sends an invitation to the second user in response to the first user's selection. For example, the invitation may be transmitted as a notification or publication within the social networking system and request that the second user enter a promotional identifier, complete another action (as described further below), or otherwise participate collaboratively with the first user in the product promotion. As described herein, collaborative participation in a product promotion may enable multiple users to increase their chances of winning a collective prize.

At block 125, the social networking system receives an indication that the second user has completed an action within the social networking system, wherein the action is associated with, or a result of the second user participating in, the promotion. An action can be directly associated with the social networking platform or indirectly associated and subsequently published to the social networking platform. Exemplary actions include: entering a proof-of-purchase or other promotional identifier into the product promotion application, inviting a user to be a participant in the promotion, having an invited user participate the promotion, downloading the promotional application, allowing an entity related to the promotion to publish to the social networking system on a user's behalf, visiting or logging into a product or company website using a social networking account, liking, following, or becoming a fan of a product or company, submitting an RSVP for an event, checking in, listening to music, watching a video, sharing content, creating new content, playing a game, answering a quiz, and trying a product.

At block 130, the social networking system increases a likelihood of the first user winning the award or a quality of the award in response to the indication that the second user completed the action. For example, depending upon how a winner of the award is selected, the first user may be granted one or more additional points towards a goal, additional entries in a sweepstakes/lottery, or generally granted a higher percentage chance of winning than the first user would otherwise have if the second user had not completed the action. In an embodiment in which collaboratively participating users share an award, the second user also has an increased likelihood or increased quality of an award as a result of the second user's completion of the action. In one embodiment, the social networking system increases the likelihood of one or more users within a group winning or increases the quality of the (shared) award in response to a group of users growing in number. The first user may add subsequent users of the social networking system, causing the group to grow. In such an embodiment, the first user acts as a “leader” of the group and is responsible for adding users. Alternatively, after the first user adds the second user, both the first and second user may add subsequent users, causing the group to grow. In another embodiment, the social networking system increases the likelihood of winning or quality of the award in response to a chain of users growing in length. For example, the first user added the second user to the chain, the second user adds a third user, and each sequential user in the chain is responsible for adding a next user. The chances of winning an award for all users previous to the last user in the chain may depend upon the last user continuing the required actions.

At block 135, the social networking system publishes an indication of the second user completing an action within the social networking system, failing to complete an action or failing to participate in the promotion. For example, if a user at the end of a chain of users fails to add a subsequent user to the chain within a threshold period of time of being added to the chain, the social networking may publish an indication of this failure to enable existing users in the chain to encourage the user at the end of the chain to act. In other embodiments, the social networking system may publish: an indication of a user action, an addition of a user to a group or chain, that a number of users in a group or chain has reached a threshold level, the status of a group or chain with respect to another user's competitive group or chain, an indication of a user not continuing to add a subsequent user after a period of time, or an indication of a user winning a prize.

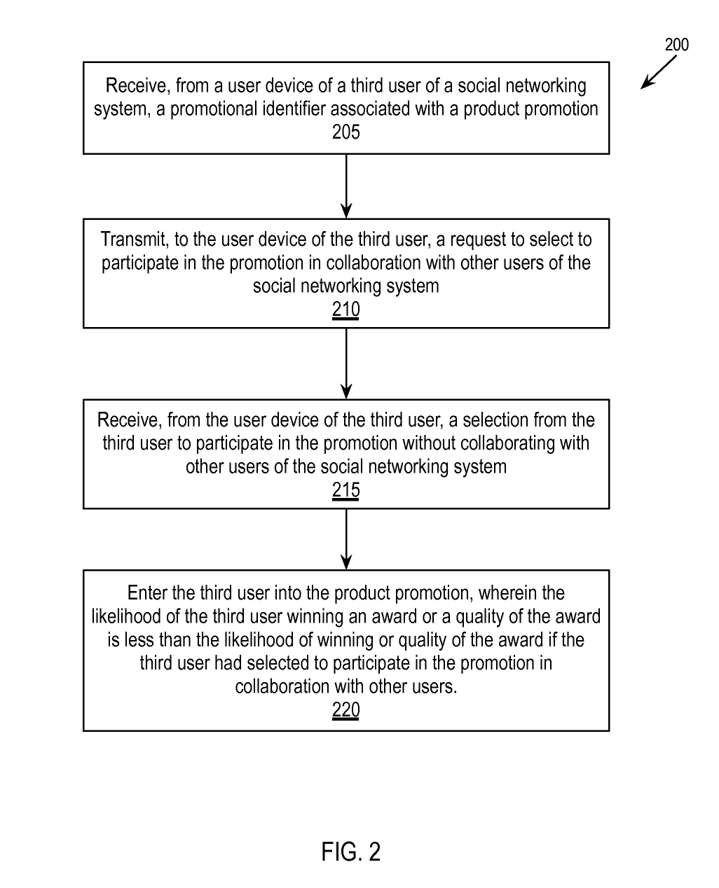

FIG. 2 is a flow chart illustrating another exemplary method 200 of implementing a product promotion through a social network. Similar to the description of FIG. 1, at block 205, the social networking system receives, from a user device of a third user of a social networking system, a promotional identifier associated with a product promotion. In one embodiment, the third user enters the promotional identifier in response to receiving an invitation to participate in the promotion, as described above with reference to FIG. 1.

At block 210, the social networking system transmits, to the user device of the third user, a request to select to participate in the promotion alone or in collaboration with other users of the social networking system. At block 215, the social networking system receives from the user device of the third user, a selection from the third user to participate in the promotion without collaborating with other users of the social networking system. For example, the social networking system may request that the user explicitly select to participate as an individual or with one or more other users. Alternatively, the social networking system may receive a choice from the third user to participate without collaborating with other users following a recommendation of a set of one or more users to invite to participate in the promotion (e.g. as described with reference to FIG. 1, block 115). In one embodiment, the selection of none of the recommended users is determined to be a selection to participate as an individual.

The social networking system, at block 220, then enters the third user into the product promotion. The likelihood of the third user winning the award or a quality of the award, however, is less than the likelihood or quality if the third user had selected to participate in the promotion in collaboration with other users. For example, the third user may select to participate alone and enter a promotional identifier (i.e., a UTC code, proof of purchase, etc.) into the third user's user device. The social networking system notifies the third user of a win or loss related to the promotional identifier. If the promotional identifier represents a loss, the product promotion ends for the third user. Alternatively, had the third user selected to participate with another user, despite a personal loss based upon the third user's promotional identifier, the third user's partner in the promotion may enter a promotional identifier that will win a prize for both users.

FIG. 3 illustrates exemplary graph 300 of social network data. In graph 300, objects are illustrated as circles and actions are illustrated as connection between circles. Developers of the social network or corresponding social network applications define actions to represent different ways that users may interact with the social network and/or their applications. As users perform actions, connections are made between users and objects. For example, User A has performed a number of actions within the social network, indicating that he previously lived in Boston, currently lives in Washington D.C., joined groups for Democrats and ConLaw Lovers, is following the White Sox, used an application to listen to the song, “Get Lucky,” and is friends with User B. User B and User C have also performed a number of actions with respect to objects within graph 300.

In one embodiment, users are able to add demographic information to user profiles 305 A-C. In one embodiment, for demographic information that has not been entered by a user, a social network application generates an estimate based upon the user's actions, connections, and/or actions of connections. For example, User B has not entered an alma mater into user profile 305B. A social network application may determine from User B's contacts, activities, cities of residence, etc. that User B's likely alma mater is one or both of Brigham Young University or Harvard University.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connection between User A and User C. An indication that two user are married may indicate a stronger affinity than if two users are friends. Additionally, temporal and geographic proximity of actions/users are other exemplary indicators of affinity.

The illustrated objects, connections, profiles, and affinity values are exemplary social network data used for determining recommendations for participation in the product promotion (e.g. as described with reference to FIG. 1, block 115). For example, if User A were participating in a product promotion that includes a prize of a private concert with Ted Nugent, the social networking system may recommend to User A to invite User B to participate in the promotion based upon User B listening to, liking, or having another interaction with the music of Ted Nugent. In one embodiment, users may select privacy settings to control what social network data is shared, with whom the data is shared, and/or what data is used for determining recommended actions.

FIG. 4 illustrates, in block diagram form, an exemplary social network 400. The exemplary social network 400 includes a social networking system 410, an external server 415, and user devices 405 coupled to one or more networks 405. A user interacts with the social networking system 410 using a user's device 405, such as a personal computer or a mobile phone. For example, the user device 405 communicates with the social networking system 410 via an application such as a web browser or native application. Typical interactions between the user's device 405 and the social networking system 410 include receiving news feed publications, operations such as viewing profiles of other users of the social networking system 410, contributing and interacting with media items, joining groups, listing and confirming attendance at events, checking in at locations, liking certain pages/posts, creating pages, and performing other tasks that facilitate social interaction. In one embodiment, typical interactions may also include entering a promotional identifier into the social networking platform, inviting a user to be a participant in the promotion, downloading the promotional application, etc. (e.g. as described with reference to FIG. 1). In one embodiment, in response to the user entering the promotional identifier into the product promotion application, the social networking system transmits the promotional identifier to a product promotion server (e.g., external server 415).

The social networking system 410 includes platform storage 425, one or more platform applications 430, one or more application programming interfaces (API's) 435, a social graph 440, and the internal product promotion application 445. Platform storage 425 stores user preferences/settings, profile data, etc. Exemplary platform applications 430 include the platform for social interactions (e.g., publishing posts, pictures, etc.) as well as social games, messaging services, playing music, and any other application that uses the social platform provided by the social networking system 410. In one embodiment, the social networking system 410 acts as the product promotion server and the internal product promotion application 445 performs one or both of methods 100 and 200, in whole or in part. Social network data (e.g. as described with reference to FIG. 3) is received from and/or stored in one or more of the external storage 455, platform storage 425, and social graph 440.

One or more API's 435 enable external applications to work with the social networking system 410. For example, an external product promotion application 450 utilizes an API 435 to authenticate a user based upon the user's social networking log in username and password. Additionally, an external application 450 utilizes one or more API's 435 to run the application within the platform application 430, to publish a post to the platform application 430, to access the user's social network connections in social graph 440, etc.

The social graph 440 stores the connections that each user has with other users/entities of the social networking system 410. In one embodiment, the social graph 440 stores second-order connections. The connections may thus be direct or indirect. For example, if user A is a first-order connection of user B but not of user C, and B is a first-order connection of C, then C is a second-order, or indirect, connection of A on the social graph 440. In one embodiment, the social graph 440 provides the product promotion application with recommended contacts/connections as described with reference to FIGS. 1 and 3.

The external server 415 includes external storage 455 and an external product promotion application 450. The external storage 455 stores authentication data, user preferences, product promotion data, feedback, etc. The external product promotion application 450 may interact with the social networking system 410 via an API 435. The external product promotion application 450 can perform various operations supported by the API 435, such as enabling users to send each other messages through the social networking system 410 or solicit users to invite other users to participate in the product promotion through the social networking system 410. In one embodiment, external server 415 acts as the product promotion server and the external product promotion application 450 performs one or both of methods 100 and 200, in whole or in part. Social network data is received from and/or stored in one or more of the external storage 455, platform storage 425, and social graph 440.

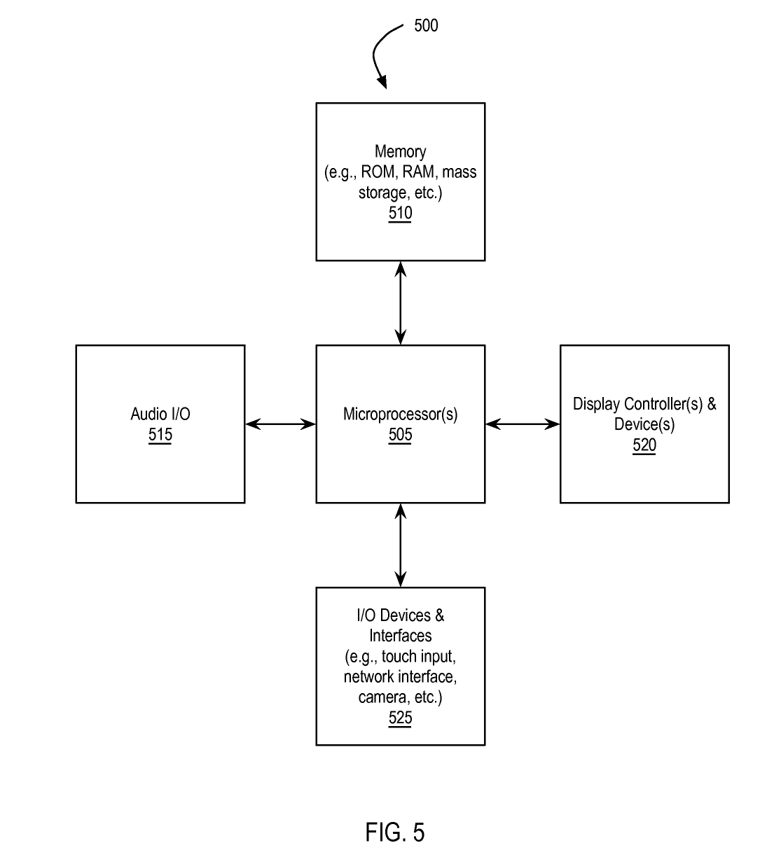

FIG. 5 illustrates, in block diagram form, an exemplary processing system 500 to implement an embodiment of a product promotion. Data processing system 500 includes one or more microprocessors 505 and connected system components (e.g., multiple connected chips). Alternatively, the data processing system 500 is a system on a chip. The data processing system 500 includes memory 510, which is coupled to the microprocessor(s) 505. The memory 510 may be used for storing data, metadata, and programs for execution by the microprocessor(s) 505. The memory 510 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 510 may be internal or distributed memory. The data processing system 500 also includes an audio input/output subsystem 515 which may include a microphone and/or a speaker for, for example, playing back music or other audio, receiving voice instructions to be executed by the microprocessor(s) 505, playing audio notifications, etc. A display controller and display device 520 provides a visual user interface for the user.

The data processing system 500 also includes one or more input or output (“I/O”) devices and interfaces 525, which are provided to allow a user to provide input to, receive output from, and otherwise transfer data to and from the system. These I/O devices 525 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 500.

The I/O devices and interfaces 525 may also include a connector for a dock or a connector for a USB interface, FireWire, Thunderbolt, Ethernet, etc. to connect the system 500 with another device, external component, or a network. Exemplary I/O devices and interfaces 525 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 500 with another device, external component, or a network and receive stored instructions, data, tokens, etc. It will be appreciated that one or more buses, may be used to interconnect the various components shown in FIG. 5.

The data processing system 500 is an exemplary representation of one or more of the user's device 405, at least a portion of the social networking system 410, or the external server 415. For example, the data processing system 500 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 500 may be a network computer, server, or an embedded processing device within another device or consumer electronic product. As used herein, the terms computer, system, device, processing device, and “apparatus comprising a processing device” may be used interchangeably with the data processing system 500 and include the above-listed exemplary embodiments.

It will be appreciated that additional components, not shown, may also be part of the system 500, and, in certain embodiments, fewer components than that shown in FIG. 5 may also be used in a data processing system 500. It will be apparent from this description that aspects of the inventions may be embodied, at least in part, in software. That is, the computer-implemented methods 100 and 200 may be carried out in a computer system or other data processing system in response to its processor or processing system executing sequences of instructions contained in a memory, such as memory 510 or other non-transitory machine-readable storage medium. The software may further be transmitted or received over a network (not shown) via a network interface device 525. In various embodiments, hardwired circuitry may be used in combination with the software instructions to implement the present embodiments. Thus, the techniques are not limited to any specific combination of hardware circuitry and software, or to any particular source for the instructions executed by the data processing system 500.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
receiving, from a user device of a first user of a social networking system, a promotional identifier associated with a promotion;
entering the first user into the promotion, wherein the user has an opportunity to win an award in response to participation in the promotion;
receiving, from the user device, a selection of a second user of the social networking system;
receiving an indication that the second user has completed an action within the social networking system, wherein the action is associated with, or a result of the second user participating in, the promotion; and
increasing a likelihood of the first user winning the award or a quality of the award in response to the indication that the second user completed the action.

2. The computer-implemented method of claim 1, wherein the increasing of the likelihood of winning or quality of the award occurs in response to a group of users growing in number, wherein the group includes the first and second users and the first user adds subsequent users or each user adds subsequent users to cause the group to grow.

3. The computer-implemented method of claim 1, wherein the increasing of the likelihood of winning or quality of the award occurs in response to a chain of users growing in length, wherein the first user added the second user to the chain and each sequential user in the chain is responsible for adding a next user.

4. The computer-implemented method of claim 1, further comprising:
publishing, to a social networking platform, an indication of the second user completing the action.

5. The computer-implemented method of claim 1, further comprising:
publishing, to a social networking platform, an indication of the second user failing to complete an action within the social networking system or failing to participate in the promotion.

6. The computer-implemented method of claim 1, further comprising:
recommending, to the first user, a set of one or more users of the social networking system from which the first user may invite to participate in the promotion, wherein the recommendation is based on an association within the social networking system between the first user and each recommended user.

7. The computer-implemented method of claim 1, further comprising:
recommending, to the first user, a set of one or more users of the social networking system from which the first user may invite to participate in the promotion, wherein the recommendation is based on an association within the social networking system between each recommended user and the promotion.

8. The computer-implemented method of claim 1, wherein the social network action is the second user entering a promotional identifier into a user device.

9. The computer-implemented method of claim 1, wherein the social network action is the second user completing a promotional engagement.

10. The computer-implemented method of claim 1, further comprising:
receiving, from a user device of a third user of a social networking system, a promotional identifier associated with a promotion;
transmitting, to the user device of the third user, a request to select to participate in the promotion in collaboration with other users of the social networking system;
receiving, from the user device of the third user, a selection from the third user to participate in the promotion without collaborating with other users of the social networking system; and
entering the third user into the promotion, wherein the third user has an opportunity to receive an award in response to participation in the promotion, and wherein a likelihood of the third user winning the award or a quality of the award is less than the likelihood or quality if the third user had selected to participate in the promotion in collaboration with other users.

11. A non-transitory computer-readable medium storing instructions, which when executed by a processing device, cause the processing device to perform method comprising:
receiving, from a user device of a first user of a social networking system, a promotional identifier associated with a promotion;
entering the first user into the promotion, wherein the user has an opportunity to win an award in response to participation in the promotion;
receiving, from the user device, a selection of a second user of the social networking system;
receiving an indication that the second user has completed an action within the social networking system, wherein the action is associated with, or a result of the second user participating in, the promotion; and
increasing a likelihood of the first user winning the award or a quality of the award in response to the indication that the second user completed the action.

12. The non-transitory computer-readable medium of claim 11, wherein the increasing of the likelihood of winning or quality of the award occurs in response to a group of users growing in number, wherein the group includes the first and second users and the first user adds subsequent users or each user adds subsequent users to cause the group to grow.

13. The non-transitory computer-readable medium of claim 11, wherein the increasing of the likelihood of winning or quality of the award occurs in response to a chain of users growing in length, wherein the first user added the second user to the chain and each sequential user in the chain is responsible for adding a next user.

14. The non-transitory computer-readable medium of claim 11, further comprising:
publishing, to a social networking platform, an indication of the second user completing the action.

15. The non-transitory computer-readable medium of claim 11, further comprising:
publishing, to a social networking platform, an indication of the second user failing to complete an action within the social networking system or failing to participate in the promotion.

16. The non-transitory computer-readable medium of claim 11, further comprising:
recommending, to the first user, a set of one or more users of the social networking system from which the first user may invite to participate in the promotion, wherein the recommendation is based on an association within the social networking system between the first user and each recommended user.

17. The non-transitory computer-readable medium of claim 11, further comprising:
recommending, to the first user, a set of one or more users of the social networking system from which the first user may invite to participate in the promotion, wherein the recommendation is based on an association within the social networking system between each recommended user and the promotion.

18. The non-transitory computer-readable medium of claim 11, wherein the social network action is the second user entering a promotional identifier into a user device.

19. The non-transitory computer-readable medium of claim 11, wherein the social network action is the second user completing a promotional engagement.

20. The non-transitory computer-readable medium of claim 11, further comprising:
receiving, from a user device of a third user of a social networking system, a promotional identifier associated with a promotion;
transmitting, to the user device of the third user, a request to select to participate in the promotion in collaboration with other users of the social networking system;
receiving, from the user device of the third user, a selection from the third user to participate in the promotion without collaborating with other users of the social networking system; and
entering the third user into the promotion, wherein the third user has an opportunity to receive an award in response to participation in the promotion, and wherein a likelihood of the third user winning the award or a quality of the award is less than the likelihood or quality if the third user had selected to participate in the promotion in collaboration with other users.
